(19) United States
(12) Patent Application Publication
(10) Pub. No.: US 2025/0200462 A1
(43) Pub. Date: Jun. 19, 2025

(54) SKILL WALLET FOR DETERMINING CANDIDATE SKILLS AND JOB DESCRIPTION COMPATIBILITY

(71) Applicant: SAP SE, Walldorf (DE)

(72) Inventors: Akash Srivastava, Lucknow (IN); Movish Verma, Mandi Gobindgarh (IN); Rohit Jalagadugula, Visakhapatnam (IN)

(21) Appl. No.: 18/539,999

(22) Filed: Dec. 14, 2023

(51) Int. Cl. G06Q 10/0631

(52) U.S. Cl. CPC G06Q 10/063112

(57) ABSTRACT

A skill wallet platform retrieves and aggregates a first plurality of tokens into a first skill wallet for a first user. Each token of the plurality of tokens corresponds to a given skill of the first user. Then, the skill wallet platform authenticates the first plurality of tokens. Next, the skill wallet platform determines a compatibility between the first skill wallet and each job listing of a plurality of job listings. In an example, the skill wallet platform generates a score for each job listing based on a compatibility between the job listing and the first skill wallet. Then, the skill wallet platform returns a given number of job listings which are most compatible with the first skill wallet, where the given number of job listings are those job listings with the highest scores.

### TECHNICAL FIELD

The present disclosure generally relates to integrating candidate skills in a skill wallet to determine compatibility with job descriptions in job listings.

### BACKGROUND

When a hiring team publishes a job description for an open position, a typical job seeker uses various keywords that can match with the job description in their resume so that their resume gets shortlisted. But almost 90% of the candidates that sit for interviews are unable to justify their resumes. Hence, the hiring team must reject these candidates in the first round. As a result, the Shortlist to Hire Ratio (H/S) is low. The investment of time and resources for conducting hiring is not justified with a low H/S ratio. Hence, an employer must face some loss in terms of time, resources, and money in their recruitment drives.

### SUMMARY

In some implementations, a skill wallet platform retrieves and aggregates a first plurality of tokens into a first skill wallet for a first user. Each token of the plurality of tokens corresponds to a given skill or a given credential of the first user. Then, the skill wallet platform authenticates the first plurality of tokens. Next, the skill wallet platform determines a compatibility between the first skill wallet and each job listing of a plurality of job listings. In an example, the skill wallet platform generates a score for each job listing based on a compatibility between the job listing and the first skill wallet. Then, the skill wallet platform returns a given number of job listings which are most compatible with the first skill wallet, where the given number of job listings are those job listings with the highest scores.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a block diagram of a system, in accordance with some example implementations of the current subject matter;

FIG. 2 illustrates an example of a set of professional insight tokens and a set of skill insight tokens of a job seeker, in accordance with some example implementations of the current subject matter;

FIG. 3 illustrates an example of a skill wallet combining tokens from multiple wallets, in accordance with some example implementations of the current subject matter;

FIG. 4 illustrates an example of a process for generating a score and job recommendations for a job seeker based on their skill wallet, in accordance with some example implementations of the current subject matter;

FIG. 5 illustrates an example of a process for performing a unification of skills with their values, in accordance with some example implementations of the current subject matter;

FIG. 6 illustrates an example of a process for determining a compatibility between job listings and a skill wallet, in accordance with some example implementations of the current subject matter;

FIG. 7A depicts an example of a system, in accordance with some example implementations of the current subject matter; and

FIG. 7B depicts another example of a system, in accordance with some example implementations of the current subject matter.

### DETAILED DESCRIPTION

One challenge in the recruiting industry is how to increase the Shortlist to Hire Ratio (H/S) using emerging technologies. These emerging technologies include Non-Fungible Tokens (NFTs) which are a type of digital asset that represents authenticity or ownership of a unique item or content. Cryptocurrencies like Ethereum (ETH) and Bitcoin are fungible which means they are interchangeable, 1 ETH will always be equal to 1 ETH, whereas NFTs are those digital assets that do not possess interchangeability. They provide proof of ownership of digital assets like digital art, virtual real state, music, and so on. NFTs contain metadata which provides additional information regarding the asset such as the asset's description or other attributes. NFTs use smart contracts which are self-executing pieces of code having predefined instructions and encoded conditions which are executed at blockchains.

NFT marketplaces are the platforms where users can buy, sell, or trade their NFTs. NFT marketplaces act as middleware between the user wallet and the NFTs stored on the blockchain. Some examples of NFT marketplaces are OpenSea, Rarible, and SuperRare. These marketplaces let users access NFTs and information related to the NFTs without the users having knowledge of the blockchain and smart contracts on which these NFTs are stored.

Web3 wallets, also known as decentralized wallets, provide a way for users to interact with dApps (decentralized applications) and manage their digital assets in a secure and user-friendly manner. These wallets are software applications built by organizations or companies and let the user access the assets that they own on a particular blockchain network. Generally wallets support many blockchains so that the user can access, at one place, the tokens they have on different chains. These wallets prioritize security by using encryption, mnemonics, secret phrases, and other methods of authentication. One of the most common web3 wallets being used today is Metamask, developed by ConsenSys Software Inc. Other examples of wallets are rainbow wallet, phantom wallet (for Solana blockchain), and many others.

The price of an NFT is determined while selling or buying the NFT. If the user is listing an NFT on a blockchain then they can list the price along with the NFT. The price of an NFT after listing depends on various factors like rarity, usability, popularity, and so on, which might change further with time. The usability of NFTs is what make users want to buy them, generally the NFTs have some usability associated with them. The usability may be access to some club or may be governance in a DAO (Decentralized Autonomous Organization).

Soul Bound Tokens (SBTs) are based on a concept derived from video games, where the assets which a player cannot transfer to another player account are termed as soul bound. Soul bound tokens can be understood as non-fungible tokens that are non-transferrable. This concept opens additional use cases for NFTs. When it is considered that these tokens cannot be transferred to another account, NFTs can be used for various purposes that may include certificates, university degrees, or government issued documents. In an example, the skills that a person possesses are defined as a soul bound token, so that each skill becomes non-transferable, and the skill should be associated with that one single user only.

In a given approach, in a first step, all of the wallets in which a user has NFTs are identified, and then a blockchain network to be searched is identified. As the user might have different NFTs on different blockchain networks, all of the blockchains on which the user has NFTs are identified so as to be able to retrieve these NFTs. Then, the blockchain data is accessed, which will be used to fetch the NFTs owned by the user. For accessing blockchain data, specific APIs (e.g., Infura, Alchemy) are used to fetch the data and different blockchain explorers may be used for the selected blockchains. For example, for Ethereum, etherscan.io may be used. Similarly, other explorers for other blockchains may be used.

After the data is retrieved via the specific APIs, the transactions that involve NFT transactions are filtered, as the user wallet may have made a number of transactions, but the transactions of interest are only those that involve NFT transfer. This may be achieved by considering that NFT transactions involve certain smart contract interactions. After retrieving the NFTs transactions related to the user wallet on different blockchains, the relevant information about that token is fetched, which may be a token identifier (ID), contract address, and metadata related to the NFT.

The last part of the approach is to consolidate the data that is retrieved in a single location. This will enable the user to be able to access their NFTs in one place. This one place or location is referred to as a skill wallet. In an example, it is ensured that the data which is fetched and stored in the skill wallet is only that data which is relevant for the user. Also, this data may be displayed in a user-friendly manner.

Specific tokens may be classified from the metadata that is retrieved from the blockchain. Alternatively, specific tokens may be classified based on their token ID or on their contract details. Ownership history associated with an NFT is also retrieved which may be used to detect the platform or organization that listed the NFT for the user. In an example, the organization or platform may store certain attributes in the metadata to make it possible to detect and classify NFTs as skill-based or non-skill based.

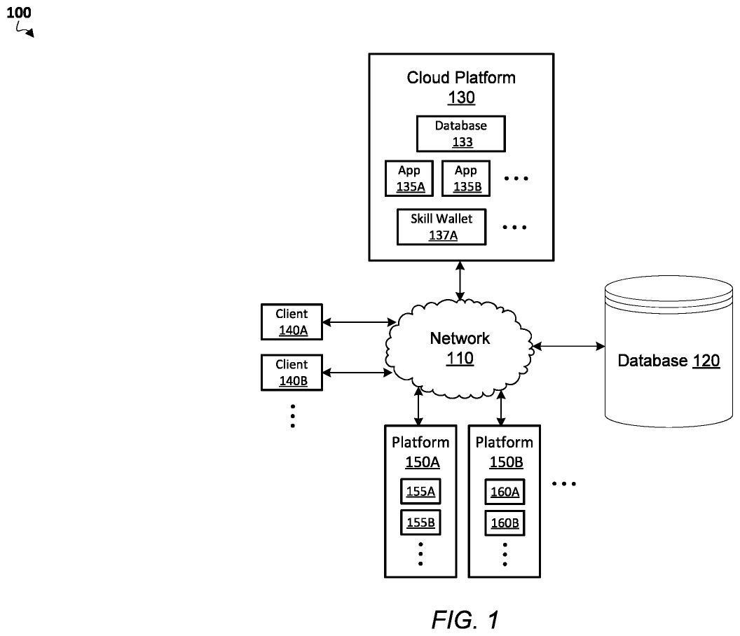

Referring now to FIG. 1, a diagram illustrating an example of a system 100 consistent with implementations of the current subject matter is depicted. In an example, the system 100 may include a cloud platform 130. The cloud platform 130 may provide resources that can be shared among a plurality of tenants. For example, the cloud platform 130 may be configured to provide a variety of services including, for example, software-as-a-service (SaaS), platform-as-a-service (PaaS), infrastructure as a service (IaaS), and/or the like, and these services can be accessed by one or more tenants of the cloud platform 130. In the example of FIG. 1, the system 100 includes a first tenant 140A (labeled client) and a second tenant 140B (labeled client as well), although system 100 may include any number of other tenants. For example, multitenancy enables multiple end-user devices (e.g., a computer including an application) as well as multiple subscribing customers having their own group of end-users with an isolated context of the particular customers to access a given cloud service having shared resources via the Internet and/or other type of network or communication link(s). Clients 140A-B may include any number of job seekers, employers, human resources (HR) staff, and/or other individuals or organizations that subscribe to cloud platform 130.

The cloud platform 130 may include resources, such as at least one computer (e.g., a server), data storage, and a network (including network equipment) that couples the computer(s) and storage. The cloud platform 130 may also include other resources, such as operating systems, hypervisors, and/or other resources, to virtualize physical resources (e.g., via virtual machines) and provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure), such that the physical resources at the cloud service provider can be shared by a plurality of tenants. Alternatively, or additionally, the cloud platform 130 may be a “private” cloud platform, in which case the resources of the cloud platform 130 may be hosted on an entity's own private servers (e.g., dedicated corporate servers operated and/or owned by the entity). Alternatively, or additionally, the cloud platform 130 may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In various embodiments, the cloud platform 130 provides services to client 140A-B. Each service may be deployed via a container, which provides a package or bundle of software, libraries, and configuration data to enable the cloud platform to deploy during runtime the service to, for example, one or more virtual machines that provide the service to client 140A. The service may also include logic (e.g., instructions that provide one or more steps of a process) and an interface. The interface may be implemented as an Open Data Protocol (OData) interface (e.g., HTTP message may be used to create a query to a resource identified via a URI), although the interface may be implemented with other types of protocols including those in accordance with REST (Representational state transfer).

In the example of FIG. 1, there are two databases 133 and 120, although other quantities of databases may be implemented as well. The first database 133 is internal to the cloud platform 130, but the second database 120 is external to the cloud platform 130, so an external REST type call may be used to send queries and receive responses from database 120. For example, when the interface is configured in accordance with REST or the ODATA protocol, the interface may access a data model, such as the client tenant schema associated with client 140A's data at database 120. And, the interface may provide a REST or Open Data Protocol (ODATA) interface to external applications and/or services, which in this case is the database 120. In the case of REST compliant interfaces, the interface may provide a uniform interface that decouples the client and server, is stateless (e.g., a request includes all information needed to process and respond to the request), cacheable at the client side or the server side, and the like.

To illustrate further, the client 140A may cause execution of a process or job on application 135A or application 135B. Applications 135A-B are representative of any number and type of applications running on cloud platform 130. In an example, an action or a condition at client 140A may cause a message querying or requesting a response from application 135A. If the response from application 135A requires a query to the database 120 in order to obtain data associated with the query, a REST call may be made to database 120. Application 135A may receive a response to the query from the database 120. The response may be compliant with REST as well. At least a portion of the noted process may execute at the cloud platform 130 (although a portion may execute at the client 140A as well). Alternatively, or additionally, the noted process may include a service extension. The service extension may represent a modification in the process (e.g., added step(s) and/or deleted step(s)) specific to, or uniquely for, the client 140A. In other words, the service extension may customize at least a portion of the process for the client 140A.

Cloud platform 130 is coupled to platforms 150A-150B, which are representative of any number and type of external platforms. In an example, platform 150A is Coursera, platform 150B is Github, and so on. In other examples, platforms 150A-150B may be other types of platforms or services which are external to cloud platform 130. As shown, platform 150A includes tokens 155A-B, which are representative of any number of tokens, NFTs, or other digital units associated with skills, experiences, or credentials for users of platform 150A. In an example, tokens 155A-B may be stored on a blockchain. Similarly, platform 150B includes tokens 160A-B which may be tokens, NFTs, or other digital units associated with skills, experiences, achievements, awards, degrees, credentials, or the like for users of platform 150B.

In an example, client 140A is a job seeker (i.e., job candidate), and cloud platform 130 maintains a skill wallet 137A for client 140A. In this example, cloud platform 130 unifies all of the tokens on platforms 150A-B that are associated with client 140A. The unification of these tokens are included as part of skill wallet 137A. For example, cloud platform 130 may authenticate each of the tokens associated with client 140A, with these tokens being stored on platforms 150A-B, and with each token corresponding to a given skill, experience, achievement, award, degree, credential, or other attribute of the job seeker. After authentication, cloud platform 130 may determine a weight for each authenticated skill and combine the skills and weights to generate an overall score for client 140A. Cloud platform 130 may associate each authenticated skill with one or more keywords or phrases. It is noted that the term “authenticated skill” may also refer to an “authenticated experience”, “authenticated achievement, “authenticated award”, “authenticated degree”, “authenticated credential”, and so on.

Then, cloud platform 130 may compare the keywords or phrases of the authenticated skills in skill wallet 137A of client 140A with the keywords or phrases of job listings. Next, cloud platform 130 rates (i.e., scores) each job based on the comparison of keywords or phrases, with a rating or score being used to measure a compatibility of skill wallet 137A to a respective job. Cloud platform 130 may return the top N jobs based on the compatibility with skill wallet 137A, where N is a positive integer, and where the value of N may vary from embodiment to embodiment.

Continuing with the above example, another client 140B may be a prospective employer. Client 140B may have a job opening, and client 140B may be searching for suitable candidates for the job opening. Client 140B may generate a request for cloud platform 130 to identify the top N job candidates for the job opening. In response to this request, cloud platform 130 may determine which skill wallets of a plurality of job seekers are most compatible with the job opening for client 140B. Cloud platform 130 may generate a score for each skill wallet based on a matching of job seeker authenticated skills to the required skills of the given job opening. Then, cloud platform 130 may return a listing of job candidates with the highest scores to client 140B. More details on this example, as well as other examples of the current subject matter, will be provided throughout the remainder of this disclosure.

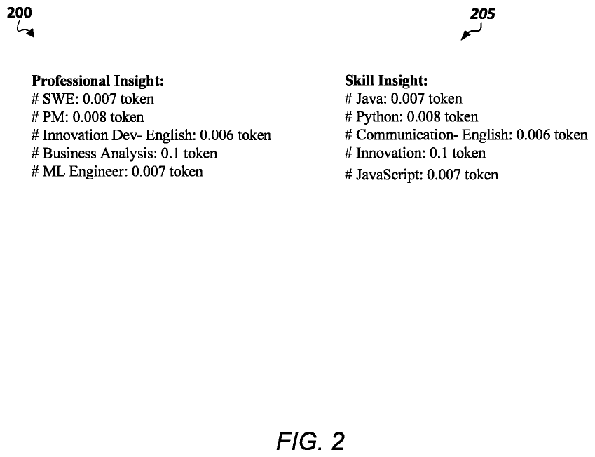

Turning now to FIG. 2, an example of a set of professional insight tokens 200 and a set of skill insight tokens 205 of a job seeker is shown, in accordance with some example implementations of the current subject matter. In an example, a job seeker may be a client of a cloud platform (e.g., cloud platform 130 of FIG. 1) which generates and maintains a skill wallet (e.g., skill wallet 137A) on behalf of the job seeker. The cloud platform may fetch and unify tokens from a plurality of external platforms when creating the skill wallet for the job seeker. Professional insight tokens 200 provide examples of the types of tokens that may be fetched and/or created for the given job seeker by the cloud platform.

Each skill of the job seeker may be associated with a token, and each token may be assigned a weight based on a determination of the value of the skill. As shown, each skill listed has an assigned token unit which represents its respective value as compared to the other skills. Also, skill insight tokens 205 includes examples of tokens assigned to the different skills of the job seeker. The cloud platform may maintain skill wallets for a plurality of job seekers, and each skill wallet may be associated with a corresponding set of professional insight tokens and skill insight tokens. These professional insight tokens and skill insight tokens may be used for generating a score to rank a compatibility of the job seeker to a given job listing relative to other job seekers.

In an example, the cloud platform may add together all of the token units of the entirety of the professional insight tokens and skill insight tokens to generate a sum for a given user. The sum may then be used as the score of the given user. In another example, the cloud platform may determine a correlation between the token units of the entirety of the professional insight tokens and skill insight tokens for a given user to a given job listing. In an example, determining a correlation may involve determining whether skills of a given user match required skills of a given job listing and then applying a specific weight to each user-skill to required-skill match. The weights applied to the matches may then be aggregated (e.g., added) to create a sum. In other examples, other correlation determination techniques may be employed.

The cloud platform may determine multiple correlations between the given user and multiple job listings. Also, the cloud platform may determine multiple correlations between multiple users and a given job listing. Additionally, the cloud platform may generate a score or metric based on the correlation of each user to each job listing. The scores or metrics may then be used to measure compatibility of a given user to a given job listing. The scores or metrics may also be used to rank a plurality of users (i.e., job seekers) for a given job listing and/or to rank a plurality of job listings for a given user.

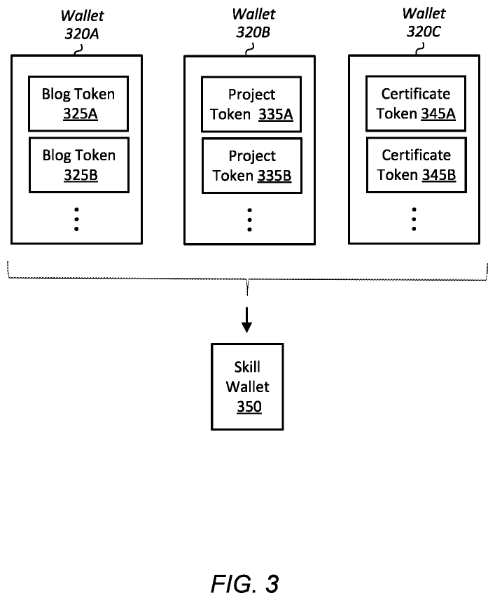

Referring now to FIG. 3, an example of a skill wallet 350 combining tokens from multiple wallets 320A-C is shown, in accordance with some example implementations of the current subject matter. In an example, a job candidate may generate and/or produce original works and receive NFTs in return. The original works may be uploaded to different types of platforms. For example, various skill-based platforms may issue tokens based on job candidates' contributions to these platforms. Also, platforms such as Coursera, Udemy, Universities, School Boards, and so on may issue tokens. Additionally, competitions may issue tokens, such as hackathons, coding contest, speaking engagements, conferences, and so on, which may result in the issuance of tokens to user who participate in these competitions. Still further, professional organizations may issue professional LOR's, certifications, recognitions, and the like. Still further, platforms such as GitHub may issue tokens for code contributed to the open source platform. Additionally, blogs, projects, and endorsements from high valued persons may also result in the generation of tokens. Candidates may store NFTs from these organizations and platforms, and these NFTs may be stored in a variety of types of wallets. A single skill wallet may link together all of these different wallets for an individual user, with the single skill wallet gathering these NFTs with different skill tags.

For example, a job candidate may have multiple different wallets, with these wallets including wallet 320A for storing blog tokens 325A-B which are representative of any number of blog tokens. The job candidate's multiple wallets also include wallet 320B and wallet 320C. Wallet 320B stores project tokens 335A-B which are representative of any number and type of project tokens, and wallet 320C stores certificate tokens 345A-B which are representative of any number and type of certificate tokens. Other types of wallets storing other types of tokens are possible and are contemplated. The blog tokens 325A-B, project tokens 335A-B, and certificate tokens 345A-B may be combined together into a single skill wallet 350. In other words, skill wallet 350 aggregates all of the tokens from wallets 320A-C.

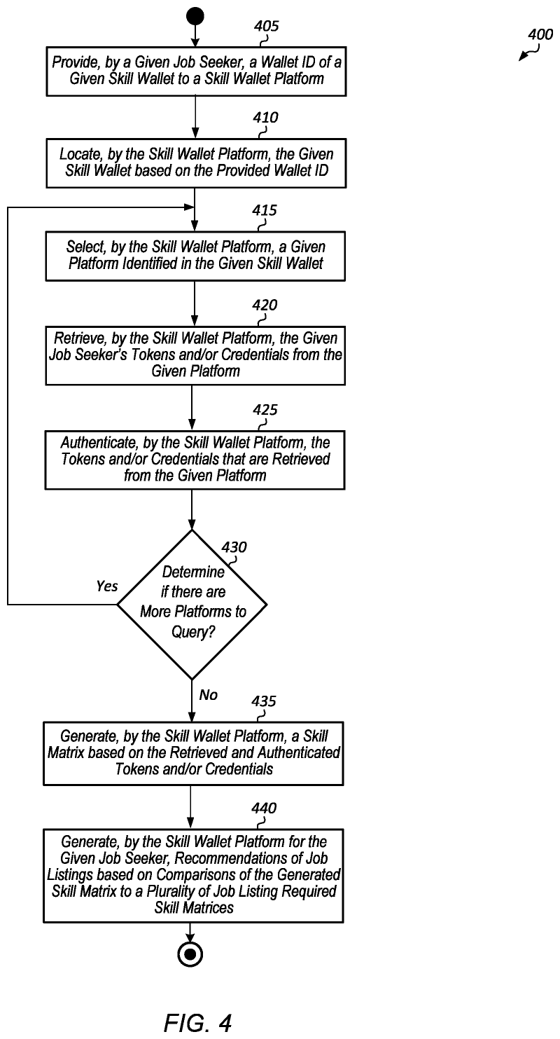

Turning now to FIG. 4, a process for generating a score and job recommendations for a job seeker based on their skill wallet is shown, in accordance with some example implementations of the current subject matter. A given job seeker provides a wallet identifier (ID) of a given skill wallet (e.g., skill wallet 350 of FIG. 3) to a skill wallet platform (e.g., cloud platform 130 of FIG. 1) (block 405). In an example, the wallet ID is a hexadecimal value. In other examples, the wallet ID may be specified and/or identified using other types of values. Next, the skill wallet platform locates the given skill wallet based on the provided wallet ID (block 410). Then, the skill wallet platform selects a given platform identified in the given skill wallet (block 415). For example, the given platform may be Coursera, Github, and so on.

Next, the skill wallet platform retrieves the given job seeker's tokens and/or credentials from the given platform (block 420). The tokens and/or credentials may include any updates that have occurred since the given skill wallet was originally created. Then, the skill wallet platform authenticates the tokens and/or credentials that are retrieved from the given platform (block 425). Next, the skill wallet platform determines if there are more platforms to query for the given job seeker based on their wallet ID (conditional block 430). If there are more platforms to query for the given job seeker based on their wallet ID (conditional block 430, “yes” leg), then method 400 returns to block 415. Otherwise, if there are no more platforms to query for the given job seeker based on their wallet ID (conditional block 430, “no” leg), then the skill wallet platform generates a skill matrix based on the retrieved and authenticated tokens and/or credentials (block 435). In an example, the skill matrix includes one or more keywords or phrases for each authenticated token or credential as well as a score or token unit for each authenticated token or credential. It is noted that the term “skill matrix” of block 435 may also be referred to as a “job seeker skill matrix”, “user skill matrix”, “skill table”, “skill array”, “skill vector”, or “wallet matrix”.

Next, the skill wallet platform generates, for the given job seeker, recommendations of job listings based on comparisons of the generated skill matrix to a plurality of job listing skill matrices (block 440). In an example, each job listing skill matrix includes a plurality of keywords or phrases for a plurality of required skills and a plurality of scores or metrics corresponding to the plurality of required skills. In an example, the comparison of a job seeker skill matrix to a job listing skill matrix is implemented by performing one or more matrix multiplication operations. In other examples, the comparison of a job seeker skill matrix to a job listing skill matrix may be implemented using other suitable techniques and/or operations. After block 440, method 400 may end.

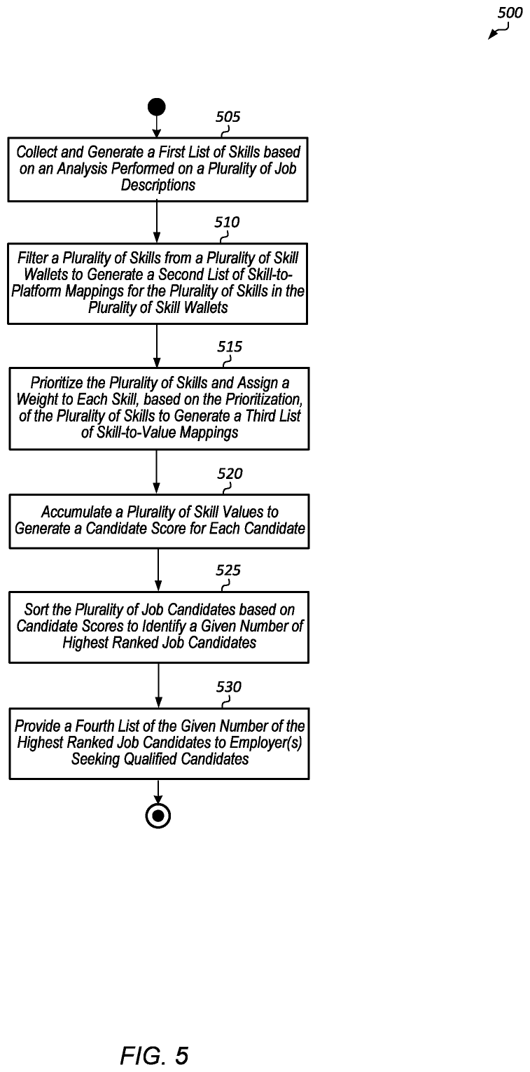

Referring now to FIG. 5, a process for performing a unification of skills with their values is shown, in accordance with some example implementations of the current subject matter. A skill wallet platform (e.g., cloud platform 130 of FIG. 1) collects and generates a first list of skills based on an analysis performed on a plurality of job descriptions (block 505). It is noted that the term “job description” may also be used interchangeably herein with “job listing” or “job opening”. The skill wallet application filters a plurality of skills from a plurality of skill wallets to generate a second list of skill-to-platform mappings for the plurality of skills in the plurality of skill wallets (block 510). It is noted that the term “platform” may be defined as a source or reference point of credentials, skills, university degrees, awards, or other qualifications of a job candidate. It is also noted that each skill wallet of the plurality of skill wallets is associated with a corresponding job candidate.

Next, the skill wallet platform prioritizes the plurality of skills and assigns a weight to each skill, based on the prioritization, of the plurality of skills to generate a third list of skill-to-value mappings (block 515). In an example, the skill wallet platform performs web crawling of job-related websites and social media platforms to determine the current trending skills and platforms based on the first list of skills and the second list of mappings. In this example, after a trend analysis is performed, the platforms and skills are quantified into a number (i.e., score) in three dimensions, with the number assigned to a platform, skill, value triplet (i.e., platform-skill-value triplet). Then, a determination of the unified value of each skill is generated from these quantifications in three dimensions.

After block 515, a plurality of skill values are accumulated to generate a candidate score for each candidate (block 520). In an example, a job description sentiment analysis algorithm is used to assign weights to the skills listed in the first list of skills. In this example, the output from the job description sentiment analysis algorithm is in the form of a map having skill as the key and weight as the value [<Skill, Weight>]. This map may be referred to as a skill aggregation matrix. The job description sentiment analysis algorithm may include both a machine learning approach and a lexicon-based approach.

After block 520, the plurality of job candidates are sorted based on candidate scores and a given number N of the highest ranked job candidates are identified, with N being a positive integer which may vary from embodiment to embodiment (block 525). A fourth list of the given number N of the highest ranked job candidates, identified in block 525, are provided to an employer or employers seeking qualified candidates (block 530). After block 530, method 500 may end. It is noted that the terms “first list”, “second list”, “third list”, and “fourth list” include the first, second, third, and fourth designators, respectively, so as to differentiate the lists from each other. Each of these lists may also be referred to without their numerical designation as simply “a list” or “the list”.

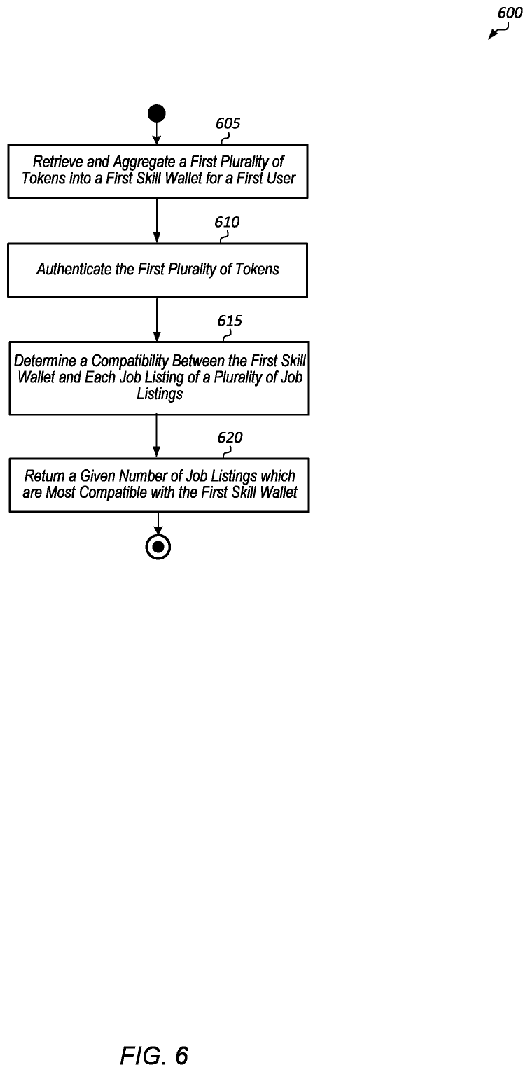

Turning now to FIG. 6, a process for determining a compatibility between job listings and a skill wallet is shown, in accordance with some example implementations of the current subject matter. A skill wallet platform (e.g., cloud platform 130 of FIG. 1) retrieves and aggregates a first plurality of tokens into a first skill wallet for a first user (block 605). Next, the skill wallet platform authenticates the first plurality of tokens (block 610). Then, the skill wallet platform determines a compatibility between the first skill wallet and each job listing of a plurality of job listings (block 615). In an example, the compatibility may be determined based on a correlation between a first set of skills represented by the tokens in the first skill wallet and a second set of skills required for a given job listing. The compatibility may be used to generate a score or a metric, such that a compatibility score or a compatibility metric is generated for the first skill wallet for each job listing.

Next, the skill wallet platform returns a given number of job listings which are most compatible with the first skill wallet (block 620). In an example, the given number of job listings which are most compatible are those job listings with a compatibility score greater than a threshold. The value of the threshold may vary from implementation to implementation. In an example, a job seeker may indicate how urgent their job search is, and the urgency of the job search may be used to determine the value of the threshold. For example, if the job seeker is already employed and relatively content, then the job seeker may specify this to the skill wallet platform, resulting in the setting of a relatively high threshold. Alternatively, in another example, if a given job seeker is unemployed, the given job seeker may specify this to the skill wallet platform, and in response, the skill wallet platform may set the threshold to a relatively low value. Setting the threshold to a relatively low value will result in a relatively higher number of job listings being returned to the given job seeker. Similarly, prospective employers may indicate an urgency of the need for job candidates to the skill wallet platform, which will cause the skill wallet platform to adjust threshold values so as to provide a higher number of job candidates to an employer for consideration. After block 620, method 600 may end.

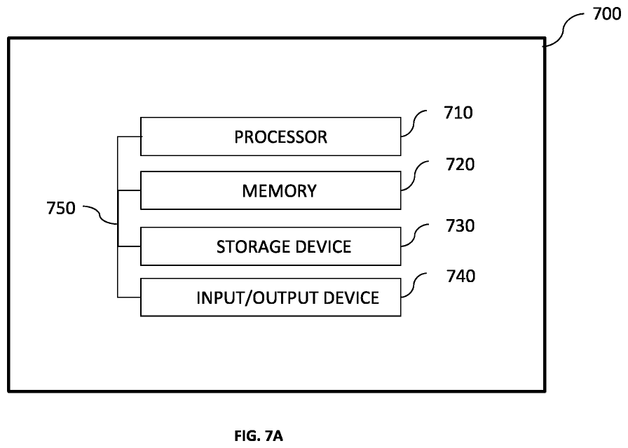

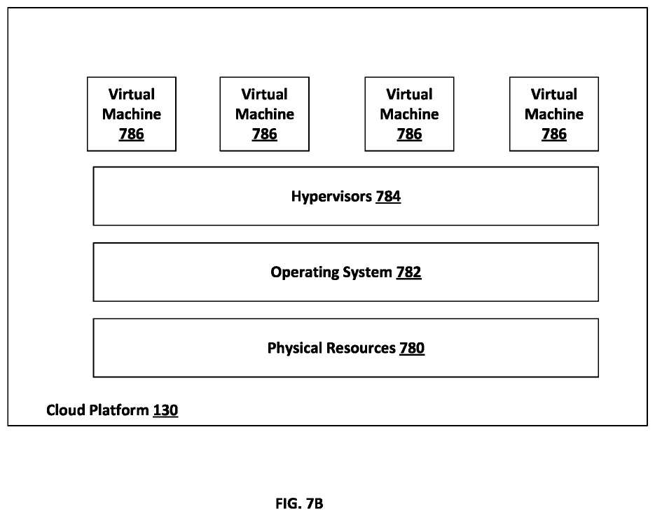

In some implementations, the current subject matter may be configured to be implemented in a system 700, as shown in FIG. 7A. The system 700 may include a processor 710, a memory 720, a storage device 730, and an input/output device 740. Each of the components 710, 720, 730 and 740 may be interconnected using a system bus 750. The processor 710 may be configured to process instructions for execution within the system 700. In some implementations, the processor 710 may be a single-threaded processor. In alternate implementations, the processor 710 may be a multi-threaded processor. The processor 710 may be further configured to process instructions stored in the memory 720 or on the storage device 730, including receiving or sending information through the input/output device 740. The memory 720 may store information within the system 700. In some implementations, the memory 720 may be a computer-readable medium. In alternate implementations, the memory 720 may be a volatile memory unit. In yet some implementations, the memory 720 may be a non-volatile memory unit. The storage device 730 may be capable of providing mass storage for the system 700. In some implementations, the storage device 730 may be a computer-readable medium. In alternate implementations, the storage device 730 may be a floppy disk device, a hard disk device, an optical disk device, a tape device, non-volatile solid state memory, or any other type of storage device. The input/output device 740 may be configured to provide input/output operations for the system 700. In some implementations, the input/output device 740 may include a keyboard and/or pointing device. In alternate implementations, the input/output device 740 may include a display unit for displaying graphical user interfaces.

FIG. 7B depicts an example implementation of a cloud platform 130 (of FIG. 1), which provides cloud services. The cloud platform 130 may be implemented using various physical resources 780, such as at least one hardware servers, at least one storage, at least one memory, at least one network interface, and the like. The cloud platform 130 may also be implemented using infrastructure, as noted above, which may include at least one operating systems 782 for the physical resources and at least one hypervisor 784 (which may create and run at least one virtual machine 786). For example, each multitenant application may be run on a corresponding virtual machine.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A method performed by a computing system, comprising: retrieving and aggregating a first plurality of tokens into a first skill wallet for a first user, wherein each token of the first plurality of tokens corresponds to a given skill of the first user; authenticating the first plurality of tokens; determining a compatibility between the first skill wallet and each job listing of a plurality of job listings; generating a score for each job listing based on a compatibility between the job listing and the first skill wallet; and returning a given number of job listings which are most compatible with the first skill wallet based on having highest scores of the plurality of job listings.

Example 2: The method of Example 1, further comprising generating, based on the authenticated first plurality of tokens, a first skill matrix for the first user, wherein the first skill matrix includes one or more keywords for each authenticated token of the authenticated first plurality of tokens.

Example 3: The method of any of Examples 1-2, further comprising comparing the first skill matrix to a plurality of job listing skill matrices corresponding to the first plurality of job listings.

Example 4: The method of any of Examples 1-3, wherein each job listing skill matrix, of the plurality of job listing skill matrices, comprises: one or more keywords for each required skill of one or more required skills for performing a corresponding job; and a score for each required skill of the one or more required skills.

Example 5: The method of any of Examples 1-4, further comprising: retrieving and aggregating a second plurality of tokens into a second skill wallet for a second user; authenticating the second plurality of tokens; generating a first score for the first skill wallet based on compatibility of the first skill wallet with a first job listing and generating a second score for the second skill wallet based on compatibility of the second skill wallet with the first job listing; and providing, to a prospective employer, an indication of which score is higher among the first and second scores based on compatibility with the first job listing.

Example 6: The method of any of Examples 1-5, wherein the first plurality of tokens are retrieved from a plurality of different platforms.

Example 7: The method of any of Examples 1-6, further comprising: detecting an update to a first token, of the first plurality of tokens, on a first platform; authenticating an updated version of the first token; and applying, based on the updated version of the first token, a first update to the first skill wallet to generate an updated first skill wallet.

Example 8: The method of any of Examples 1-7, further comprising regenerating the first score based on the updated skill wallet.

Example 9: The method of any of Examples 1-8, further comprising: generating a first list of skills based on an analysis performed on the plurality of job listings, wherein each job listing of the plurality of job listings comprises one or more skills required for a corresponding job; filtering a plurality of skills from a plurality of skill wallets to generate a second list of skill-to-platform mappings for the plurality of skills in the plurality of skill wallets; prioritizing the plurality of skills and assigning a weight to each skill, based on the prioritization, of the plurality of skills to generate a third list of skill-to-value mappings; accumulating a plurality of skill values to generate a candidate score for each job candidate of a plurality of job candidates; sorting the plurality of job candidates based on candidate scores; and identifying a given number of highest ranked job candidates based on the sorting of the plurality of job candidates based on the candidates scores.

Example 10: The method of any of Examples 1-9, further comprising: generating a fourth list of the given number of the highest ranked job candidates; and providing the fourth list of the given number of the highest ranked job candidates to one or more employers.

Example 11: A system, comprising: at least one processor; and at least one memory including program instructions which when executed by the at least one processor cause operations comprising: retrieving and aggregating a first plurality of tokens into a first skill wallet for a first user, wherein each token of the first plurality of tokens corresponds to a given skill of the first user; authenticating the first plurality of tokens; determining a compatibility between the first skill wallet and each job listing of a plurality of job listings; generating a score for each job listing based on a compatibility between the job listing and the first skill wallet; and returning a given number of job listings which are most compatible with the first skill wallet based on having highest scores of the plurality of job listings.

Example 12: The system of Example 11, wherein the program instructions are further executable by the at least one processor to cause operations comprising generating, based on the authenticated first plurality of tokens, a first skill matrix for the first user, wherein the first skill matrix includes one or more keywords for each authenticated token of the authenticated first plurality of tokens.

Example 13: The system of any of Examples 11-12, wherein the program instructions are further executable by the at least one processor to cause operations comparing the first skill matrix to a plurality of job listing skill matrices corresponding to the first plurality of job listings.

Example 14: The system of any of Examples 11-13, wherein each job listing skill matrix, of the plurality of job listing skill matrices, comprises: one or more keywords for each required skill of one or more required skills for performing a corresponding job; and a score for each required skill of the one or more required skills.

Example 15: The system of any of Examples 11-14, wherein the program instructions are further executable by the at least one processor to cause operations comprising: retrieving and aggregating a second plurality of tokens into a second skill wallet for a second user; authenticating the second plurality of tokens; generating a first score for the first skill wallet based on compatibility of the first skill wallet with a first job listing and generating a second score for the second skill wallet based on compatibility of the second skill wallet with the first job listing; and providing, to a prospective employer, an indication of which score is higher among the first and second scores based on compatibility with the first job listing.

Example 16: The system of any of Examples 11-15, wherein the first plurality of tokens are retrieved from a plurality of different platforms.

Example 17: The system of any of Examples 11-16, wherein the program instructions are further executable by the at least one processor to cause operations comprising: detecting an update to a first token, of the first plurality of tokens, on a first platform; authenticating an updated version of the first token; and applying, based on the updated version of the first token, a first update to the first skill wallet to generate an updated first skill wallet.

Example 18: The system of any of Examples 11-17, wherein the program instructions are further executable by the at least one processor to cause operations comprising regenerating the first score based on the updated skill wallet.

Example 19: The system of any of Examples 11-18, wherein the program instructions are further executable by the at least one processor to cause operations: generating a first list of skills based on an analysis performed on the plurality of job listings, wherein each job listing of the plurality of job listings comprises one or more skills required for a corresponding job; filtering a plurality of skills from a plurality of skill wallets to generate a second list of skill-to-platform mappings for the plurality of skills in the plurality of skill wallets; prioritizing the plurality of skills and assigning a weight to each skill, based on the prioritization, of the plurality of skills to generate a third list of skill-to-value mappings; accumulating a plurality of skill values to generate a candidate score for each job candidate of a plurality of job candidates; sorting the plurality of job candidates based on candidate scores; and identifying a given number of highest ranked job candidates based on the sorting of the plurality of job candidates based on the candidates scores.

Example 20: A non-transitory computer readable medium storing instructions, which when executed by at least one data processor, cause operations comprising: retrieving and aggregating a first plurality of tokens into a first skill wallet for a first user, wherein each token of the first plurality of tokens corresponds to a given skill of the first user; authenticating the first plurality of tokens; determining a compatibility between the first skill wallet and each job listing of a plurality of job listings; generating a score for each job listing based on a compatibility between the job listing and the first skill wallet; and returning a given number of job listings which are most compatible with the first skill wallet based on having highest scores of the plurality of job listings.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A method performed by a computing system, comprising:
retrieving and aggregating a first plurality of tokens into a first skill wallet for a first user, wherein each token of the first plurality of tokens corresponds to a given skill of the first user;
authenticating the first plurality of tokens;
determining a compatibility between the first skill wallet and each job listing of a plurality of job listings;
generating a score for each job listing based on a compatibility between the job listing and the first skill wallet; and
returning a given number of job listings which are most compatible with the first skill wallet based on having highest scores of the plurality of job listings.

2. The method of claim 1, further comprising generating, based on the authenticated first plurality of tokens, a first skill matrix for the first user, wherein the first skill matrix includes one or more keywords for each authenticated token of the authenticated first plurality of tokens.

3. The method of claim 2, further comprising comparing the first skill matrix to a plurality of job listing skill matrices corresponding to the first plurality of job listings.

4. The method of claim 3, wherein each job listing skill matrix, of the plurality of job listing skill matrices, comprises:
one or more keywords for each required skill of one or more required skills for performing a corresponding job; and
a score for each required skill of the one or more required skills.

5. The method of claim 1, further comprising:
retrieving and aggregating a second plurality of tokens into a second skill wallet for a second user;
authenticating the second plurality of tokens;
generating a first score for the first skill wallet based on compatibility of the first skill wallet with a first job listing and generating a second score for the second skill wallet based on compatibility of the second skill wallet with the first job listing; and
providing, to a prospective employer, an indication of which score is higher among the first and second scores based on compatibility with the first job listing.

6. The method of claim 5, wherein the first plurality of tokens are retrieved from a plurality of different platforms.

7. The method of claim 6, further comprising:
detecting an update to a first token, of the first plurality of tokens, on a first platform;
authenticating an updated version of the first token; and
applying, based on the updated version of the first token, a first update to the first skill wallet to generate an updated first skill wallet.

8. The method of claim 7, further comprising regenerating the first score based on the updated skill wallet.

9. The method of claim 1, further comprising:
generating a first list of skills based on an analysis performed on the plurality of job listings, wherein each job listing of the plurality of job listings comprises one or more skills required for a corresponding job;
filtering a plurality of skills from a plurality of skill wallets to generate a second list of skill-to-platform mappings for the plurality of skills in the plurality of skill wallets;
prioritizing the plurality of skills and assigning a weight to each skill, based on the prioritization, of the plurality of skills to generate a third list of skill-to-value mappings;
accumulating a plurality of skill values to generate a candidate score for each job candidate of a plurality of job candidates;
sorting the plurality of job candidates based on candidate scores; and
identifying a given number of highest ranked job candidates based on the sorting of the plurality of job candidates based on the candidates scores.

10. The method of claim 9, further comprising:
generating a fourth list of the given number of the highest ranked job candidates; and
providing the fourth list of the given number of the highest ranked job candidates to one or more employers.

11. A system, comprising:
at least one processor; and
at least one memory including program instructions which when executed by the at least one processor cause operations comprising:
retrieving and aggregating a first plurality of tokens into a first skill wallet for a first user, wherein each token of the first plurality of tokens corresponds to a given skill of the first user;
authenticating the first plurality of tokens;
determining a compatibility between the first skill wallet and each job listing of a plurality of job listings;
generating a score for each job listing based on a compatibility between the job listing and the first skill wallet; and
returning a given number of job listings which are most compatible with the first skill wallet based on having highest scores of the plurality of job listings.

12. The system of claim 11, wherein the program instructions are further executable by the at least one processor to cause operations comprising generating, based on the authenticated first plurality of tokens, a first skill matrix for the first user, wherein the first skill matrix includes one or more keywords for each authenticated token of the authenticated first plurality of tokens.

13. The system of claim 12, wherein the program instructions are further executable by the at least one processor to cause operations comprising comparing the first skill matrix to a plurality of job listing skill matrices corresponding to the first plurality of job listings.

14. The system of claim 13, wherein each job listing skill matrix, of the plurality of job listing skill matrices, comprises:
one or more keywords for each required skill of one or more required skills for performing a corresponding job; and
a score for each required skill of the one or more required skills.

15. The system of claim 11, wherein the program instructions are further executable by the at least one processor to cause operations comprising:
retrieving and aggregating a second plurality of tokens into a second skill wallet for a second user;
authenticating the second plurality of tokens;
generating a first score for the first skill wallet based on compatibility of the first skill wallet with a first job listing and generating a second score for the second skill wallet based on compatibility of the second skill wallet with the first job listing; and
providing, to a prospective employer, an indication of which score is higher among the first and second scores based on compatibility with the first job listing.

16. The system of claim 15, wherein the first plurality of tokens are retrieved from a plurality of different platforms.

17. The system of claim 16, wherein the program instructions are further executable by the at least one processor to cause operations comprising:
detecting an update to a first token, of the first plurality of tokens, on a first platform;
authenticating an updated version of the first token; and
applying, based on the updated version of the first token, a first update to the first skill wallet to generate an updated first skill wallet.

18. The system of claim 17, wherein the program instructions are further executable by the at least one processor to cause operations comprising regenerating the first score based on the updated skill wallet.

19. The system of claim 11, wherein the program instructions are further executable by the at least one processor to cause operations:
generating a first list of skills based on an analysis performed on the plurality of job listings, wherein each job listing of the plurality of job listings comprises one or more skills required for a corresponding job;
filtering a plurality of skills from a plurality of skill wallets to generate a second list of skill-to-platform mappings for the plurality of skills in the plurality of skill wallets;
prioritizing the plurality of skills and assigning a weight to each skill, based on the prioritization, of the plurality of skills to generate a third list of skill-to-value mappings;
accumulating a plurality of skill values to generate a candidate score for each job candidate of a plurality of job candidates;
sorting the plurality of job candidates based on candidate scores; and
identifying a given number of highest ranked job candidates based on the sorting of the plurality of job candidates based on the candidates scores.

20. A non-transitory computer readable medium storing instructions, which when executed by at least one data processor, cause operations comprising:
retrieving and aggregating a first plurality of tokens into a first skill wallet for a first user, wherein each token of the first plurality of tokens corresponds to a given skill of the first user;
authenticating the first plurality of tokens;
determining a compatibility between the first skill wallet and each job listing of a plurality of job listings;
generating a score for each job listing based on a compatibility between the job listing and the first skill wallet; and
returning a given number of job listings which are most compatible with the first skill wallet based on having highest scores of the plurality of job listings.
